(19) United States
(12) Patent Application Publication
(10) Pub. No.: US 2002/0063052 A1
(43) Pub. Date: May 30, 2002

(54) Process for removing arsenic compounds from the distillation bottoms from the preparation of hydrogen fluoride

(76) Inventors: Axel Peters, Leverkusen (DE); Gunter Lailach, Krefeld (DE); Reinhold Klipper, Koln (DE)

Correspondence Address: BAYER CORPORATION, PATENT DEPARTMENT, 100 BAYER ROAD, PITTSBURGH, PA, 15205, US

(21) Appl. No.: 09/971,854

(22) Filed: Oct. 4, 2001

(30) Foreign Application Priority Data
Oct. 9, 2000 (DE) 10049805.1

(51) Int. Cl. C01B 7/19; B01D 3/34; B01D 15/04

(52) U.S. Cl. 203/31; 203/41; 203/71; 203/86; 423/87; 423/472; 423/484; 423/617

(57) ABSTRACT

The invention relates to a novel process for removing arsenic compounds using amino/ammonium-functionalized anion exchangers from the distillation bottoms obtained in the purification of hydrogen fluoride by distillation.

### BACKGROUND OF THE INVENTION

The invention relates to a novel process for removing arsenic(V) compounds from the distillation bottoms from the purification of hydrogen fluoride by distillation. In the process of the invention, this removal of arsenic(V) compounds is achieved by means of amino/ammonium-functionalized anion exchangers.

The purification of hydrogen fluoride customarily involves the oxidation of the arsenic present in the oxidation state (III) in the hydrogen fluoride by means of an oxidant. The oxidation can be carried out during or preferably before the distillation. The oxidation converts the arsenic into an arsenic(V) compound that is relatively non-volatile and can be separated from the hydrogen fluoride by distillation. The subsequent distillation gives a low-arsenic hydrogen fluoride as product from the top and an arsenic-rich mixture comprising the arsenic(V) compounds together with water, sulfuric, acid and hydrogen fluoride as bottom product. The arsenic(V) compounds are present in the distillation bottoms as hexafluoroarsenate ions.

According to the prior art, the work-up of the bottom product can be carried out by converting the hexafluoroarsenate ion into sparingly soluble calcium arsenate under various conditions (cf., for example, EP-A 660,803 and U.S. Pat. No. 5,089,241).

However, the processes described in the prior art are complicated and lead to a product (i.e., Ca(AsO₃)₂) that exceeds the leachate limits for landfills in Germany by a factor of 60 and thus has to be stored in landfills for hazardous waste.

It is therefore an object of the present invention to remove arsenic(V) compounds, particularly hexafluoroarsenate compounds, under economical conditions from the distillation bottom from the preparation of hydrogen fluoride and to convert them into a form that can be deposited in a landfill. It has surprisingly been found that amino/ammonium-functionalized anion exchangers are able to absorb the AsF₆ ion highly selectively from acidic aqueous solutions.

### SUMMARY OF THE INVENTION

The present invention provides a process for removing arsenic compounds in the oxidation state (V) ( particularly hexafluoroarsenate compounds) from the distillation bottoms formed in the purification of hydrogen fluoride by distillation comprising bringing the distillation bottoms into contact with at least one amino- and/or ammonium-functionalized anion exchanger.

### DETAILED DESCRIPTION OF THE INVENTION

When carrying out the process of the invention, the arsenic compounds in the oxidation state (V) are preferably first generated by treating the arsenic(III)-containing hydrogen fluoride with an oxidant. Many oxidants suitable for this purpose are known from the prior art, e.g.: chromium(IV) oxide, elemental chlorine, elemental fluorine, elemental fluorine in the presence of alkali metal fluorides, potassium permanganate, chlorates, and peroxides, halogen fluorides, hydrogen peroxide in the presence of a catalyst, electrochemical oxidation, and oxygen difluoride. However, preference is given to oxidation using an oxidant selected from the group consisting of fluorine, chlorine, halogen fluorides, oxygen difluoride, and hydrogen peroxide or by electrochemical oxidation. The amount of oxidant should be such that very complete conversion of the arsenic(III) compounds into hexafluoroarsenate compounds is ensured.

The subsequent distillation of hydrogen fluoride can be carried out, for example, at atmospheric pressure or under a pressure of from 0.5 to 2 bar (abs.). Hydrogen fluoride is vaporized until an AsF₆-containing bottom product containing not more than 90% by weight (preferably not more than 75% by weight, particular preferably not more than 60% by weight) of HF is obtained. The distillation is preferably carried out in two process stages. In the first stage, preference is given to taking off a bottom product containing at least 95% by weight of HF (particularly preferably at least 98% by weight of HF) from a column made of carbon steel at temperatures at the bottom of less than 30° C. and a pressure of preferably from 0.9 to 1 bar (abs.). The bottom product, which contains water, sulfate, and hexa-fluoroarsenate ions, is then evaporated in a second stage, preferably in an evaporator protected against corrosion by a plastic lining and preferably at a pressure of from 0.9 to 1 bar (abs.), until the HF content is not more than 90% by weight (preferably not more than 75% by weight and particularly preferably not more than 60% by weight).

According to the invention, the AsF₆-containing mixture obtained as distillation bottoms is, preferably after mixing with from 10 to 100 times its amount of water, brought into contact with at least one amino- and/or ammonium-functionalized anion exchanger. Anion exchangers suitable for the process of the invention are anion exchangers containing quaternary ammonium groups and/or primary and/or tertiary amino groups, either individually or as any mixture with one another. It has been found that anion exchangers containing primary and/or tertiary amino groups absorb the AsF₆ ion highly selectively from acidic aqueous solutions. Anion exchangers containing quaternary ammonium groups also absorb AsF₆ ions from neutralized mixtures, with an exchange capacity comparable to that in absorption from acidic mixtures. In the process of the present invention, particular preference is given to anion exchangers containing tertiary amino groups because of their selectivity.

Thus, according to the invention, the AsF₆ ions are preferably removed from acidic or neutralized aqueous systems using anion exchangers that contain quaternary ammonium groups or from acidic aqueous systems using anion exchangers containing tertiary and/or primary amino groups. Both heterodisperse and monodisperse (or homodisperse) anion exchangers are suitable for carrying out the process of the invention, but preference is given to using monodisperse anion exchangers.

To achieve both minimal arsenic contents in the purified liquid and a maximum arsenic loading of the anion exchangers, preference is given to bringing a plurality of anion exchangers having a decreasing AsF₆ loading successively into contact with the mixture from which the arsenic is to be removed, in a manner known from the prior art.

The anion exchangers used according to the invention are preferably in the form of heterodisperse or monodisperse bead polymers.

Suitable anion exchangers comprise crosslinked polymers of ethylenically monounsaturated monomers that consist predominantly of at least one compound selected from the group consisting of styrene, vinyltoluene, ethylstyrene, or α-methylstyrene or their ring-halogenated derivatives such as chlorostyrene. They can additionally contain one or more compounds selected from the group consisting of vinylbenzyl chloride, acrylic acid and its salts and esters, particularly its methyl esters, also vinylnaphthalenes, vinylxylenes, and the nitriles and amides of acrylic and methacrylic acids. Preference is given to polymers of styrene-divinyl-benzene or polyacrylates in heterodisperse or, preferably, monodisperse form.

The monodisperse anion exchangers to be used according to the present application are described, for example, in DE-A 19 940 864.

Heterodisperse ion exchangers can be obtained by functionalization of heterodisperse bead polymers. The preparation of heterodisperse bead polymers by suspension polymerization is well known: see, for example, Ullmann's Encyclopedia of Industrial Chemistry, Vol. A 14, page 396.

Examples of heterodisperse anion exchangers which can be used according to the present invention are also given in U.S. Pat. No. 3,716,482 or U.S. Pat. No. 3,637,535, the contents of which are incorporated by reference into the present application.

The preferred monodisperse anion exchangers have the functional groups of the formulae (1) and/or (2),

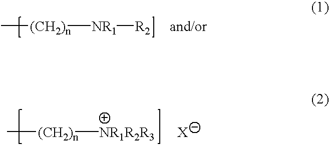

where

R₁ represents hydrogen, an alkyl group, a hydroxyalkyl group, or an alkoxyalkyl group,

R₂ represents hydrogen, an alkyl group, an alkoxy group, or a hydroxyalkyl group,

R₃ represents hydrogen, an alkyl group, an alkoxyalkyl group, or a hydroxyalkyl group,

n represents a number from 1 to 5 (particularly preferably 1), and

x represents an anionic counterion (preferably Cl⁻, Br⁻, OH^{-, NO}₃⁻, or SO₄²⁻).

In each of the radicals R₁ , R₂, and R₃, each alkoxy or alkyl preferably has from 1 to 6 carbon atoms.

In the anion exchangers used according to the invention, each aromatic ring preferably bears from 0.1 to 2 of the above-mentioned functional groups (1) and/or (2).

For the purposes of the present invention, monodisperse materials are ones in which at least 90% by volume or by mass of the particles have a diameter within 10% of the diameter corresponding to the maximum in the particle size distribution. For example, for a bead polymer for which the spheres have a particle diameter distribution with a maximum at 0.50 mm, at least 90% by volume or by mass of the beads are then within a size range from 0.45 mm to 0.55 mm, or for a bead polymer for which the spheres have a particle diameter distribution with a maximum at 0.70 mm, at least 90% by volume or % by mass of the beads are in a size range from 0.77 to 0.63 mm. For the purposes of the present invention, bead polymers that deviate therefrom are designated as heterodisperse.

The ion exchangers can be microporous or gel or macroporous bead polymers.

The terms microporous or gel or macroporous are known from the technical literature, for example from Adv. Polymer Sci., Vol. 5, pages 113-213 (1967).

Macroporous bead polymers have a pore diameter of about 50 angstrom and above.

When porogens are not used, ion exchangers having a microporous or gel structure are obtained.

As amines for introducing the functional groups, preference is given to using trimethylamine, dimethylaminoethanol, triethylamine, tripropyl amine, tributylamine, ammonia, urotropin, and aminodiacetic acid. These form anion exchangers containing quaternary ammonium groups or primary or secondary amino groups, for example, aminomethyl groups, dimethylaminomethyl groups, trimethylaminomethyl groups, dimethyl-aminoethylhydroxyethyl groups, iminodiacetic acid groups, thiourea groups, or aminomethylphosphonic acid groups.

Bead polymers containing aminomethyl groups can be converted by means of chloroacetic acid into ion exchangers containing iminodiacetic acid groups or by means of formalin/phosphorus(III) compounds into ion exchangers containing aminomethylphosphonic acid groups.

However, macroporous or gel anion exchangers based on acrylic esters can also be used for removing the arsenic-containing anions.

Practical experiments on the process of the present invention have shown that anion exchangers containing quaternary ammonium groups are preferable for adsorption from neutral or slightly alkaline, aqueous solutions. For adsorption from acidic solutions, both ion exchangers containing quaternary ammonium groups and ion exchangers containing tertiary or primary amino groups or mixtures thereof are suitable. With regard to the selectivity of the adsorption of AsF₆−, preference is given to anion exchangers containing tertiary amino groups.

Owing to the favorable hydrodynamic properties, which become particularly evident in the case of highly dilute solutions, particular preference is given to monodisperse ion exchange resins. In view of the adsorption of AsF₆− ions, it is advisable to convert all arsenic ions to be absorbed in the adsorption media into hexafluoroarsenic acid or compounds thereof (preferably salts of hexafluoroarsenic acid, particularly preferably the sodium or potassium salt of hexafluoroarsenic acid), which are adsorbed particularly preferentially on the ion exchangers used according to the invention.

The AsF₆—saturated anion exchanger can either be deposited in a suitable landfill for hazardous waste or can be incinerated in an incineration plant that is provided with facilities for removing arsenic.

The process of the invention is illustrated by the examples without the scope and spirit of the invention being restricted thereby. Those skilled in the art will readily understand that known variations of the conditions of the following procedures can be used. Unless otherwise noted, all temperatures are degrees Celsius and all percentages are percentages by weight.

### EXAMPLES

### Example 1

Hydrogen fluoride containing 37 ppm of AsF_{3,} 34 ppm of H₂SO₄, and about 110 ppm of H₂O was brought into contact with a mixture of 10% by volume of F₂ in N₂ so as to convert AsF₃ into HAsF₆. The hydrogen fluoride was subsequently distilled in a column made of ferritic steel at a temperature at the bottom of 25° C.. The hydrogen fluoride taken off at the top and condensed contained less than 50 ppb of As, less than 1 ppm of H₂SO₄, and less than 30 ppm of H₂O.

In a vaporizer made of corrosion-resistant materials, HF was vaporized from the bottom product. When various boiling temperatures in the range from 38 to 80° C. were reached, samples were taken, analyzed, and used for removal of the arsenic by means of ion exchangers.

Composition in % by weight

| Sample | HAsF₆ | H₂SO₄ | H₂O | HF |
|---|---|---|---|---|
| A | 3.33 | 2.13 | 6.9 | 87.6 |
| B | 5.74 | 3.68 | 11.9 | 78.7 |
| C | 12.90 | 8.35 | 26.8 | 52.0 |

For the absorption experiments, the samples were diluted 1:100 with water. The anion exchangers used were various Lewatit® resins that differed in terms of the active groups, the particle size distribution, and the total exchange capacity (“TC”):

| Se- | | | | |
|---|---|---|---|---|
| quen- | | | | |
| tial | Lewatit ® | Particle size | Anion exchanger based | TC |
| No. | grade | distribution | on styrene-divinylbenzene | (eq/l) |
| I | MP600WS | heterodisperse | containing | 1.4 |
| | | | dimethylhydroxy- | |
| | | | ethylammonium | |
| | | | groups | |
| II | MP62WS | heterodisperse | containing dimethylamino | 1.85 |
| | | | groups | |
| III | MP64ZII | heterodisperse | Containing aminomethyl | 2.28 |
| | | | groups | |
| IV | VPOC1094 | monodisperse | containing 25% of | 1.79 |
| | | | trimethyl-amino and 75% | |
| | | | of dimethyl-amino groups | |

The ion exchanger was in each case suspended in the diluted solution. After 2 hours, a sample was analyzed and the saturation of the ion exchanger with AsF₆ ions was calculated.

The results are listed in the following table:

| Experiment | | Ion | Residual content in | Saturation |
|---|---|---|---|---|
| No. | Sample | exchanger | solution ppm of As | % of TC |
| 1.1 | A | IV | 250 | 38 |
| 1.2 | B | IV | 96 | 88 |
| 1.3 | C | IV | 60 | 94 |
| 1.4 | C | III | 80 | 47 |
| 1.5 | C | II | 18 | 53 |
| 1.6 | C | I | 68 | 57 |
| 1.7 | C | I | 3 | 37 |

### Example 2

Sample C from Example 1 was neutralized with NaOH, and ion exchanger I (Lewatit® MP600WS) was suspended therein. At a residual As content of 76 ppm in the solution, a degree of saturation of 53% was calculated for the ion exchanger.

### Example 3

The solution obtained from Experiment 1.3, Example 1, was admixed with an amount of ion exchanger IV (Lewatit® VPOC1094) such that a maximum saturation by AsF₆ ions of 10% of the TC could be achieved. The As content of the solution after contact with the ion exchanger for 2 hours was less than 50 ppb of As.

What is claimed is:

1. A process for removing arsenic compounds in the oxidation state (V) from the distillation bottoms obtained in the purification of hydrogen fluoride by distillation comprising bringing the distillation bottoms into contact with at least one amino- and/or ammonium-functionalized anion exchanger.

2. A process according to claim 1 wherein the arsenic compounds in the oxidation state (V) are hexafluoroarsenate compounds.

3. A process according to claim 1 wherein the distillation bottoms are obtained in the purification of hydrogen fluoride by first treating arsenic(III)-containing hydrogen fluoride with an oxidant and subsequently distilling off hydrogen fluoride until a bottom product containing not more than 90% by weight of HF is obtained.

4. A process according to claim 3 wherein the distillation of hydrogen fluoride is carried out in two process stages, wherein a bottom product containing at least 95% by weight of HF is taken off at temperatures at the bottom of less than 30° C. in the first stage and the bottom product is then evaporated in an evaporator protected against corrosion by plastic lining in a second stage until the HF content is not more than 90% by weight.

5. A process according to claim 1 wherein the distillation bottoms are diluted with from 10 to 100 times their volume of water before being brought into contact with the anion exchanger.

6. A process according to claim 1 wherein the anion exchanger contains quaternary ammonium groups and/or primary and/or tertiary amino groups or mixtures thereof.

7. A process according to claim 1 wherein the anion exchanger contains tertiary amino groups.

8. A process according to claim 1 wherein the anion exchanger is a homodisperse or heterodisperse anion exchanger based on a crosslinked polymer of styrene-divinylbenzene or polyacrylate.
